(19) United States
(12) Patent Application Publication
(10) Pub. No.: US 2025/0317569 A1
(43) Pub. Date: Oct. 9, 2025

(54) METHOD AND DEVICE FOR STORING MOTION VECTOR FOR INTRA PREDICTION BLOCK

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/865,195

(22) PCT Filed: Apr. 21, 2023
(86) PCT No.: PCT/KR2023/005490

§ 371 Date: Nov. 12, 2024

(30) Foreign Application Priority Data
May 13, 2022 (KR) 10-2022-0058737
Apr. 19, 2023 (KR) 10-2023-0051377

(51) Int. Cl. H04N 19/139; H04N 19/119; H04N 19/124; H04N 19/132; H04N 19/159; H04N 19/176

(52) U.S. Cl. CPC H04N 19/139; H04N 19/119; H04N 19/124; H04N 19/132; H04N 19/159; H04N 19/176

(57) ABSTRACT

A method and a device are disclosed for storing motion vectors for intra prediction blocks. In particular, a video decoding device generates a prediction block of the current block based on intra prediction using reconstructed neighboring samples or generates the prediction block and motion information based on inter prediction using reconstructed pictures, reconstructed motion vector field, and neighboring motion information. The video decoding device stores motion information corresponding to a position of the current block in the motion vector field of the current block based on a prediction mode according to the intra prediction or motion information according to the inter prediction, position information of the current block, and size information of the current block.

### CROSS-REFERENCE TO RELATED APPLICATION

This application is a U.S. national stage of International Application No. PCT/KR2023/005490, filed on Apr. 21, 2023, which claims priority to Korean Patent Application No. 10-2022-0058737, filed on May 13, 2022, and Korean Patent Application No. 10-2023-0051377, filed on Apr. 19, 2023, the entire contents of each of which are hereby incorporated herein by reference.

### TECHNICAL FIELD

The present disclosure relates to a method and an apparatus for storing motion vectors for intra prediction blocks.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Related art video coding technology may store motion vectors used in inter prediction in the form of a motion vector field for later use. Here, the motion vector field may have a grid shape having a specific block size, and each grid may store two motion vectors. In addition, the related art video coding technology may compress the motion vector field and store the compressed motion vector field in frame units after the coding of a current frame is completed, for later use in a subsequent frame. Here, if any block is intra-predicted, the motion vector field of the corresponding block is all filled with 0, so the corresponding motion vector field cannot be used as a spatial or temporal motion vector later. Therefore, in order to improve video coding efficiency, a method of storing motion vector information for intra-predicted blocks needs to be considered.

### SUMMARY

The present disclosure seeks to provide a video coding method and an apparatus that derive and store motion vector information for an intra-predicted block for later use in order to improve video coding efficiency and video quality.

At least one aspect of the present disclosure provides a method of reconstructing a current block, performed by a video decoding device. The method includes acquiring a compressed motion vector field and reconstructed pictures from a decoded picture buffer. The method also includes generating a reconstructed motion vector field by dequantizing the compressed motion vector field. The method also includes generating a prediction block of the current block based on intra prediction using reconstructed neighboring samples or generating the prediction block and motion information based on inter prediction using the reconstructed pictures, the reconstructed motion vector field, and neighboring motion information. Here, the motion information includes a prediction mode, a motion vector, and a reference list index. The method also includes storing motion information corresponding to a position of the current block in the motion vector field of the current block based on a prediction mode according to the intra prediction or motion information according to the inter prediction, position information of the current block, and size information of the current block.

Another aspect of the present disclosure provides a method of encoding a current block, performed by a video encoding device. The method includes acquiring a compressed motion vector field and reconstructed pictures from a decoded picture buffer. The method also includes generating a reconstructed motion vector field by dequantizing the compressed motion vector field. The method also includes generating a prediction block of the current block based on intra prediction using reconstructed neighboring samples or generating the prediction block and motion information based on inter prediction using the reconstructed pictures, the reconstructed motion vector field, and neighboring motion information. Here, the motion information includes a prediction mode, a motion vector, and a reference list index. The method also includes storing motion information corresponding to a position of the current block in the motion vector field of the current block based on a prediction mode according to the intra prediction or motion information according to the inter prediction, position information of the current block, and size information of the current block.

Yet another aspect of the present disclosure provides a computer-readable recording medium storing a bitstream generated by a video encoding method. The video encoding method includes acquiring a compressed motion vector field and reconstructed pictures from a decoded picture buffer. The video encoding method also includes generating a reconstructed motion vector field by dequantizing the compressed motion vector field. The video encoding method also includes generating a prediction block of current block based on intra prediction using reconstructed neighboring samples or generating the prediction block and motion information based on inter prediction using the reconstructed pictures, the reconstructed motion vector field, and neighboring motion information. Here, the motion information includes a prediction mode, a motion vector, and a reference list index. The video encoding method also includes storing motion information corresponding to a position of the current block in the motion vector field of the current block based on a prediction mode according to the intra prediction or motion information according to the inter prediction, position information of the current block, and size information of the current block.

As described above, the present disclosure provides a video coding method and an apparatus that derive and store motion vector information for an intra-predicted block for later use. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a block diagram illustrating a video encoding device according to an embodiment of the present disclosure.

FIG. 7 is a block diagram illustrating a video decoding device according to an embodiment of the present disclosure.

FIG. 8 is a block diagram illustrating a predictor according to an embodiment of the present disclosure.

FIG. 9 is a diagram illustrating an operation of a motion vector storage according to an embodiment of the present disclosure.

FIG. 10 is a block diagram illustrating a predictor according to another embodiment of the present disclosure.

FIG. 11 is a diagram illustrating the generation of motion information for an intra-predicted block according to an embodiment of the present disclosure.

FIG. 12 is a block diagram illustrating a motion vector field compressor according to an embodiment of the present disclosure.

FIG. 13 is a diagram illustrating an operation of a sampler according to an embodiment of the present disclosure.

FIG. 14 is a block diagram illustrating a motion vector field compressor according to another embodiment of the present disclosure.

FIG. 15 is a diagram illustrating an operation of an intra prediction region padder according to an embodiment of the present disclosure.

FIG. 16 is a flowchart illustrating a method of encoding a current block by a video encoding device according to an embodiment of the present disclosure.

FIG. 17 is a flowchart illustrating a method of decoding a current block by a video decoding device according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

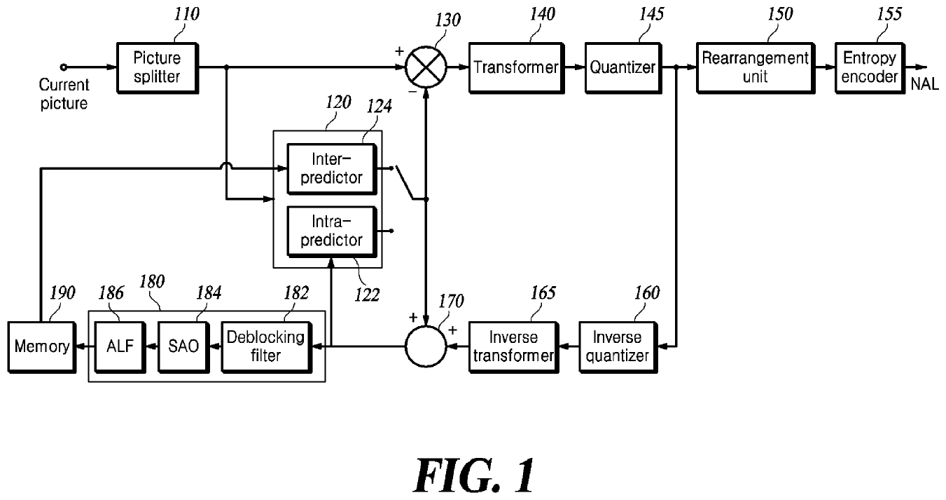

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUS included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

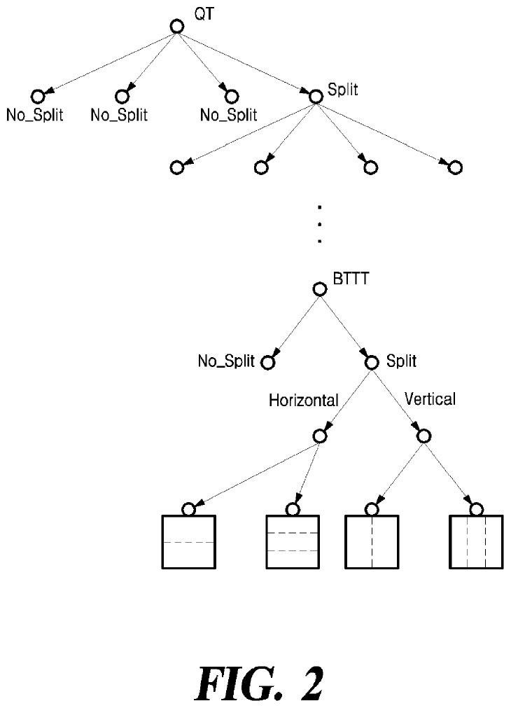

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

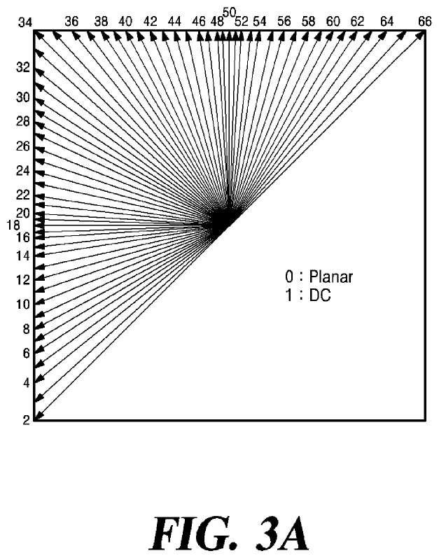

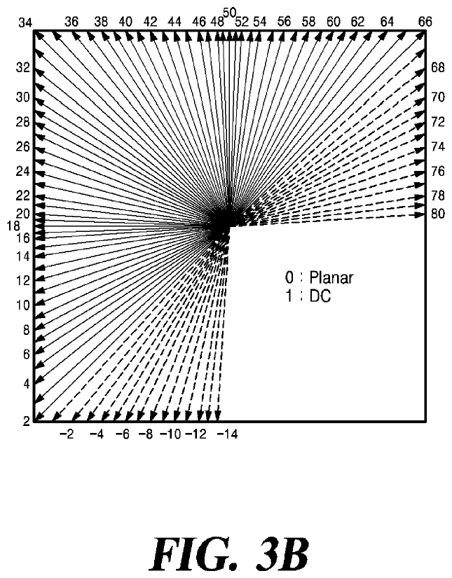

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

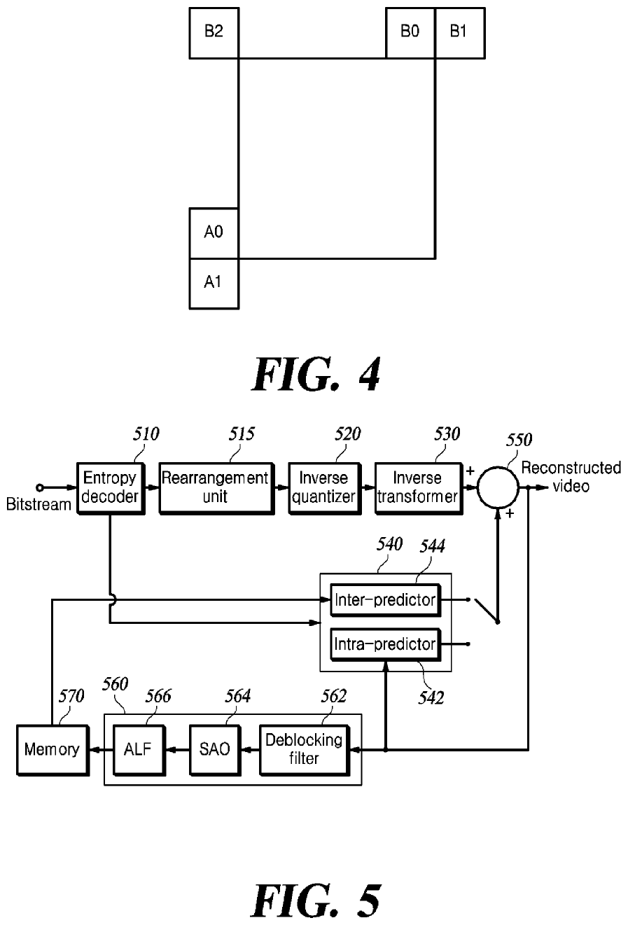

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that derive and store motion vector information for an intra-predicted block for later use.

The following embodiments may be performed by the predictor 120 in the video encoding device. The following embodiments may also be performed by the predictor 540 in the video decoding device.

The video encoding device in the prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the prediction of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

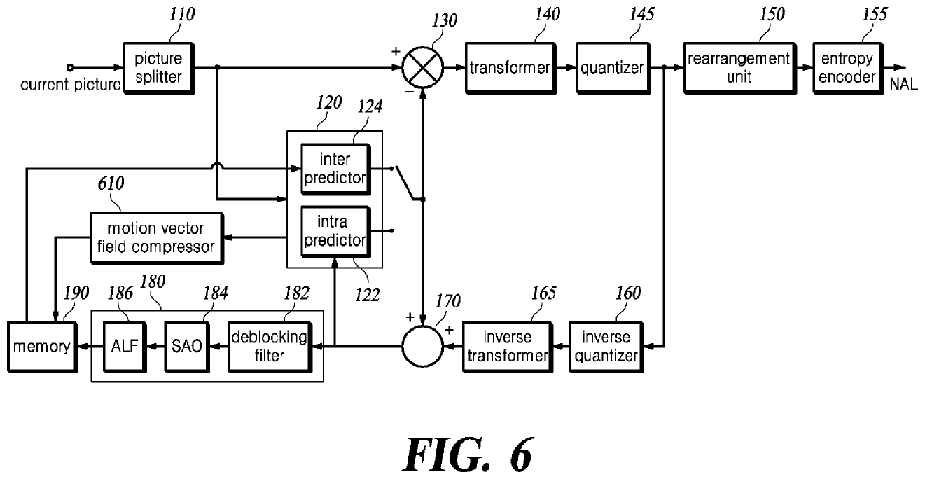

FIG. 6 is a block diagram illustrating a video encoding device according to an embodiment of the present disclosure.

Compared to the example of FIG. 1, the video encoding device in the example of FIG. 6 additionally includes a motion vector field compressor 610.

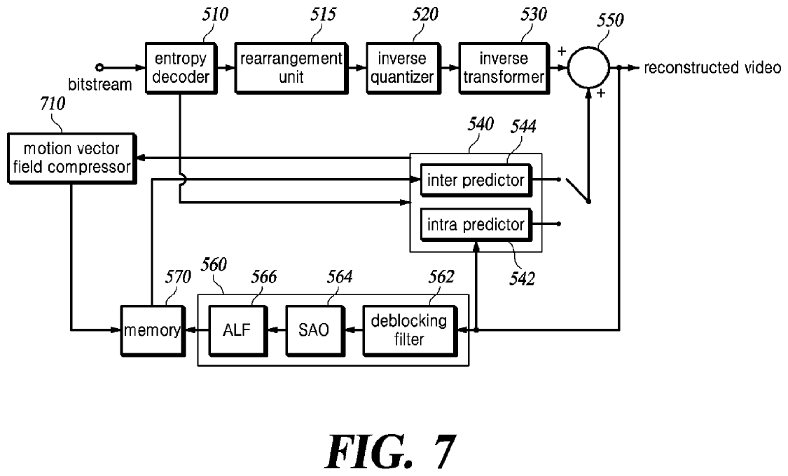

FIG. 7 is a block diagram illustrating an image decoding device according to an embodiment of the present disclosure.

Compared to the example of FIG. 5, the image decoding device in the example of FIG. 7 further includes a motion vector field compressor 710.

In order to describe an operation of the motion vector field compressor 610 added in terms of the video encoding device, an operation of the predictor 120 is first described.

Meanwhile, the operation of the motion vector field compressor 710 added to the image decoding device is the same as the operation of the motion vector field compressor 610 included in the video encoding device, so a description thereof is omitted.

Hereinafter, in order to describe the operation of the motion vector field compressor 610, the operation of the predictor 120 is first described.

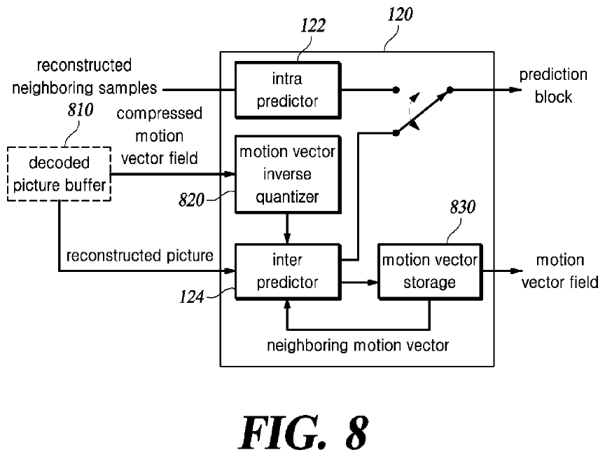

FIG. 8 is a block diagram illustrating a predictor according to an embodiment of the present disclosure.

The predictor 120 may generate a prediction block and a motion vector field by receiving a reconstructed neighboring sample of the current frame, a reconstructed picture of a previous frame, and a compressed motion vector field and performing a prediction on a current block. The subtractor 130 generates a residual block by subtracting a prediction block generated from the original block generated by the picture splitter 110. The generated residual block may be input to the transformer 140. The adder 170 adds the prediction block and the reconstructed residual block generated by the inverse transformer 165 to reconstruct the current block. The reconstructed current block may be input to the loop filter unit 180. Meanwhile, the predictor 120 may transfer the generated motion vector to the motion vector field compressor 610.

The predictor 120 may further include a decoded picture buffer 810, a motion vector inverse quantizer 820, and a motion vector storage 830 in addition to the intra predictor 122 and the inter predictor 124.

The intra predictor 122 may generate a prediction block of the current block according to the intra prediction mode using reconstructed neighboring samples. The predictor 120 may output the generated prediction block.

The decoded picture buffer 810 exists in the memory 190 and stores reconstructed pictures filtered by the loop filter unit 180. In addition, the decoded picture buffer 810 also stores the compressed motion vector field generated by the motion vector field compressor 610.

The motion vector inverse quantizer 820 receives the compressed motion vector field stored in the decoded picture buffer 810. The motion vector inverse quantizer 820 may dequantize the compressed motion vector field to reconstruct the motion vector field. The reconstructed motion vector field may be transferred to the inter predictor 124.

The inter predictor 124 may receive reconstructed pictures, reconstructed motion vector field, and neighboring motion information, may perform inter prediction, and may generate a prediction block of the current block. The predictor 120 may output the generated prediction block. In addition, the inter predictor 124 may transfer motion information used for inter prediction to the motion vector storage 830. Here, the motion information may include a prediction mode, a motion vector, a reference list index, and the like. In addition, position information and size information of the current block may be transmitted to the motion vector storage 830.

The inter predictor 124 may use the corresponding information as neighboring motion information if the motion vector and a reference list index are stored in a corresponding position of the motion vector field even though the prediction mode of the neighboring block is the intra prediction mode. In other words, the corresponding information may be used as the neighboring motion information in the process of generating a merge candidate list, an advance motion vector predictor (AMVP) candidate list, an affine candidate list, or the like.

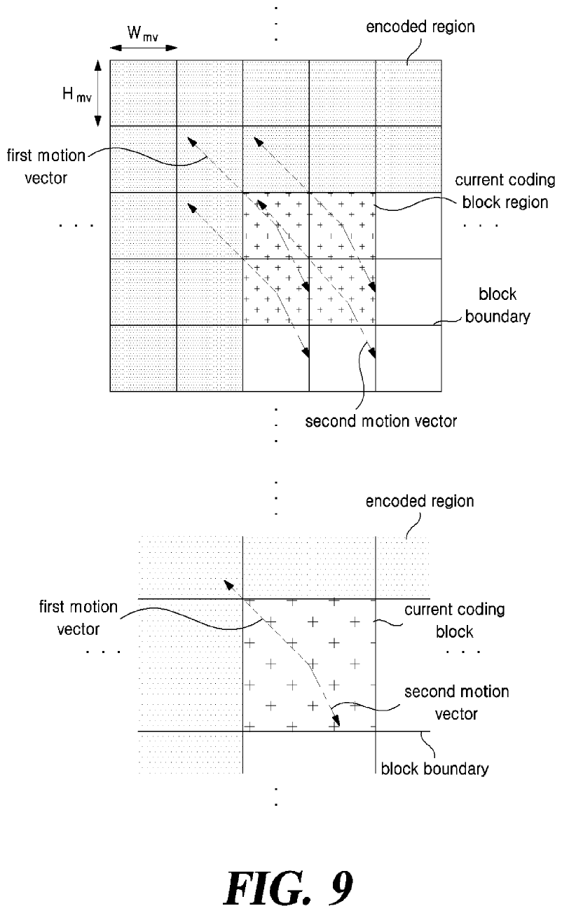

The motion vector storage 830 receives the motion information, block position, and size information and stores the motion information corresponding to the current block position in the motion vector field. Here, as in the example of FIG. 9, the motion vector storage 830 divides the current coding block region corresponding to the current block into grids of the motion vector field. The motion vector storage 830 may copy the prediction mode, the first motion vector, the second motion vector, and the reference list index included in the motion information of the current block and then may store the copied motion information in each grid within the current coding block region of the motion vector field.

In the example of FIG. 9, the lower illustration represents the current block, i.e., the current coding block. In addition, the upper illustration represents the current coding block region, which is a region including grids. In the example of FIG. 9, the current coding block region includes four grids, and the four grid regions store the same motion information. In the example of FIG. 9, Wₘᵥ represents the width of the grid, and Hₘᵥ represents the height of the grid.

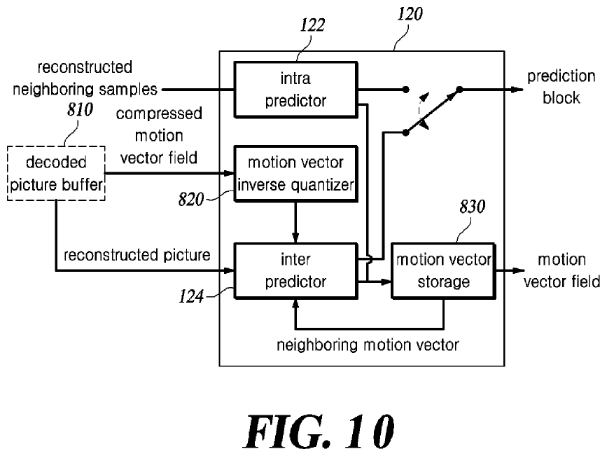

FIG. 10 is a block diagram illustrating a predictor according to another embodiment of the present disclosure.

As described above, the predictor 120 may receive the reconstructed neighboring sample of the current frame, the reconstructed picture of the previous frame, and the compressed motion vector field and perform prediction on the current block to generate a prediction block and a motion vector field. The subtractor 130 subtracts the generated prediction block from the original block generated by the picture splitter 110 to generate a residual block. The generated residual block may be input to the transformer 140. The adder 170 adds the prediction block to the reconstructed residual block generated by the inverse transformer 165 to reconstruct the current block. The reconstructed current block may be input to the loop filter unit 180. Meanwhile, the predictor 120 may transfer the generated motion vector to the motion vector field compressor 610.

As described above, the predictor 120 may further include the decoded picture buffer 810, the motion vector inverse quantizer 820, and the motion vector storage 830 in addition to the intra predictor 122 and the inter predictor 124.

The intra predictor 122 may generate a prediction block of the current block according to the intra prediction mode using the reconstructed neighboring samples. The predictor 120 may output the generated prediction block. As illustrated in FIG. 10, the intra predictor 122 may transfer the size and position information of the current block to the motion vector storage 830. In addition, the intra predictor 122 may transfer the prediction mode to the motion vector storage 830.

The motion vector inverse quantizer 820 receives the compressed motion vector field stored in the decoded picture buffer 810. The motion vector inverse quantizer 820 may dequantize the compressed motion vector field to reconstruct the motion vector field. The reconstructed motion vector field may be transferred to the inter predictor 124.

The inter predictor 124 may receive the reconstructed pictures, the reconstructed motion vector field, and the neighboring motion information and may perform inter prediction to generate a prediction block of the current block. The predictor 120 may output the generated prediction block. In addition, the inter predictor 124 may transmit the motion information used for inter prediction to the motion vector storage 830. As described above, the motion information may include a prediction mode, a motion vector, a reference list index, and the like. In addition, the position information and the size information of the current block may be transmitted to the motion vector storage 830.

The motion vector storage 830 receives the motion information, the block position, and the size information and stores the motion information corresponding to the current block position in the motion vector field. Here, as in the example of FIG. 9, the motion vector storage 830 divides the current coding block region corresponding to the current block into grids of the motion vector field. The motion vector storage 830 may copy the prediction mode, a first motion vector, a second motion vector, and a reference list index included in the motion information of the current block, and then may store the copied motion information in each grid within the current coding block region of the motion vector field.

Meanwhile, if the input prediction mode is an intra prediction mode, as in the example of FIG. 11, the motion vector storage 830 derives the motion vector and the reference list index of the current block using the motion information stored in the pre-encoded neighboring motion information region. In addition, the motion vector storage 830 may store the motion information derived for the current block in the motion vector field.

As an example, as a method for generating the motion vector and reference list index of the current block, a method for generating a merge candidate list generated for inter prediction may be used. In other words, the motion vector storage 830 may generate a merge candidate list for the current block and then may use a motion vector and a reference list index of a first candidate in the merge list as motion information of the current block.

As another example, top motion information or the left motion information may be used based on the shape of the current block. Here, the top motion information and the left motion information may be the closest top motion information and the closest left adjacent based on the top left of the current block. For example, in terms of the shape of the block, if a horizontal length of the block is longer than a vertical length, the left motion information may be used as motion information of the current block. Meanwhile, if the vertical length is longer than the horizontal length, the top motion information may be used as the current motion information. If the shape of the current block is square, the left motion information or the top motion information may be used.

Hereinafter, an operation of the motion vector field compressor 610 is described.

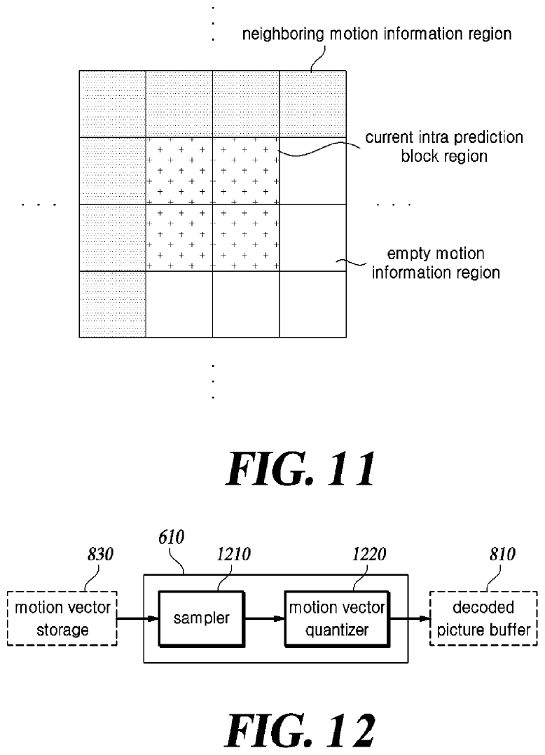

FIG. 12 is a block diagram illustrating a motion vector field compressor according to an embodiment of the present disclosure.

The motion vector field compressor 610 collects inputted block-unit motion vectors to generate a picture-unit motion vector field, and then compresses the picture-unit motion vector field. The motion vector field compressor 610 may transfer the compressed motion vector field to the decoded picture buffer 810.

The motion vector field compressor 610 may include a sampler 1210 and a motion vector quantizer 1220.

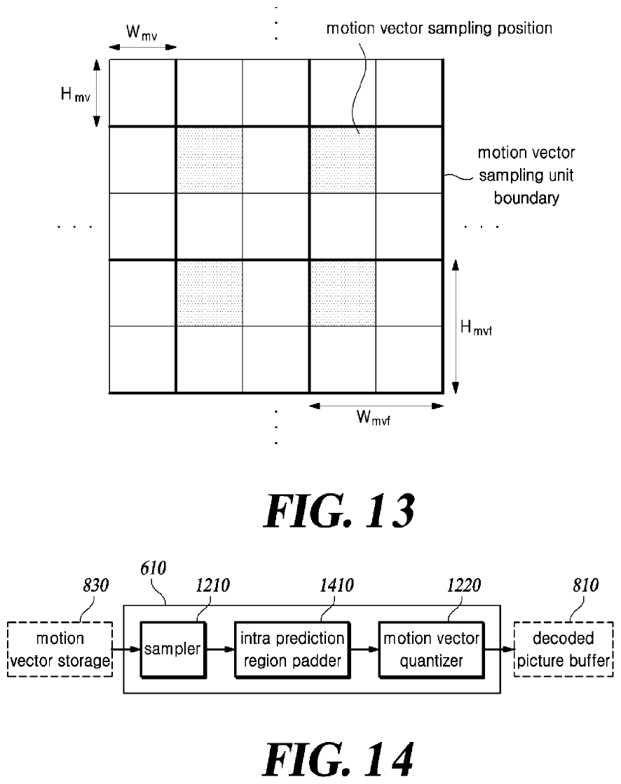

The sampler 1210 may sample the motion vector field in motion vector sampling units and may transfer the sampled motion vector field to the motion vector quantizer 1220. As in the example of FIG. 13, sampling may be performed in horizontal and vertical units that are twice as large as the units of the motion vector field. Here, the position of the motion vector field sampled in the motion vector sampling unit may be the top left. For example, the unit of the motion vector field may be 4×4, and the motion vector sampling unit may be 8×8. In other words, the motion vector field compressor 610 may downsample the motion vector field by twice and then may store the downsampled motion vector field in the decoded picture buffer 810. In the example of FIG. 13, W_{mvf} represents a width of the motion vector sampling unit, and H_{mvf} represents a height of the motion vector sampling unit.

The motion vector quantizer 1220 may perform compression by quantizing the size of the motion vector included in the sampled motion vector field. The motion vector field compressor 610 may output the compressed motion vector field to be stored in the decoded picture buffer 810.

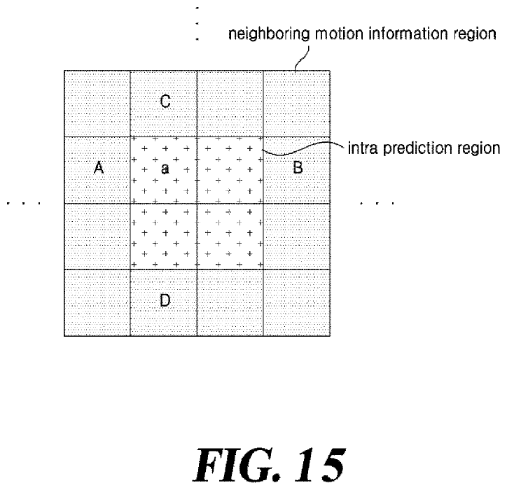

FIG. 14 is a block diagram illustrating a motion vector field compressor according to another embodiment of the present disclosure.

The motion vector field compressor 610 may further include an intra prediction region padder 1410 in addition to the sampler 1210 and the motion vector quantizer 1220.

The sampler 1210 may sample the motion vector field in a motion vector sampling unit and may transfer the same to the intra prediction region padder 1410, as in the example of FIG. 13.

The intra prediction region padder 1410 may perform padding using motion information included in neighboring motion information regions for the region in which intra prediction is performed in the sampled motion vector field. For example, in order to generate motion information at position a in the example of FIG. 15, the intra prediction region padder 1410 may use motion information at positions A, B, C, and D.

As an example, a distance-based weighted sum may be used as a method of generating a motion vector from motion information. Here, the distance represents a distance between an intra prediction region and a neighboring motion information region in the example of FIG. 15. When the weighted sum method is used, the intra prediction region padder 1410 may normalize the sizes of all motion vectors based on a difference between a picture order count (POC) of a current picture and a POC of a reference picture, and then may perform a distance-based weighted sum of the normalized motion vectors to generate a motion vector of the intra prediction region.

In addition, one reference list index of the motion information used in the above-described weighted sum may be used as a reference list index of the weighted motion vector. Here, the intra prediction region padder 1410 may determine whether the neighboring motion information is available in a preset order and then may select first available motion information. Thereafter, the intra prediction region padder 1410 may set a reference list index of the weighted motion vector to a reference list index of the selected motion information. Here, the preset order may be determined based on the above-described distance. Alternatively, the preset order may be an order of the top, left, bottom, and right of the intra prediction region. Alternatively, the preset order may be the order of the top, bottom, left, and right of the intra prediction region.

As another example, the motion information of the closest neighboring motion information region based on the distance may be used as motion information of the intra prediction region.

The decoded picture buffer 810 may receive and store the reconstructed current picture and the compressed motion vector field. The stored picture and motion vector field may be transferred to the predictor 120 for picture coding later.

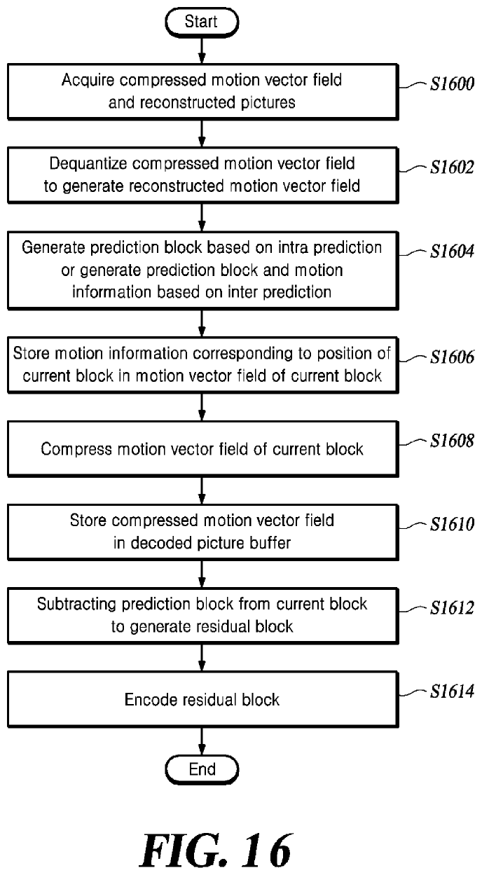

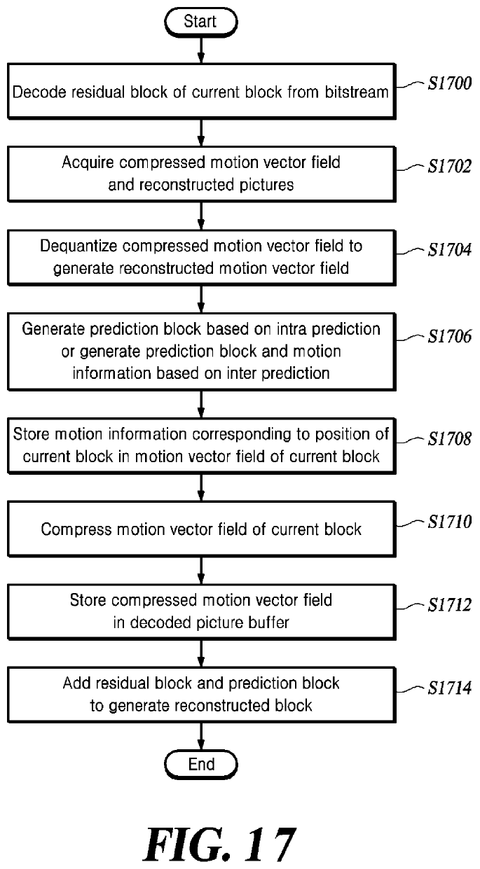

Hereinafter, a method of encoding/decoding a current block using intra prediction or inter prediction using the illustrations of FIGS. 16 and 17 is described.

FIG. 16 is a flowchart illustrating a method of encoding a current block by a video encoding device according to an embodiment of the present disclosure.

The video encoding device acquires a compressed motion vector field and reconstructed pictures from the decoded picture buffer (S1600).

The video encoding device dequantizes the compressed motion vector field to generate a reconstructed motion vector field (S1602).

The video encoding device generates a prediction block of the current block according to intra prediction, or generates a prediction block and motion information based on inter prediction (S1604). Here, the motion information includes a prediction mode, a motion vector, and a reference list index.

The video encoding device may generate a prediction block of the current block according to intra prediction using reconstructed neighboring samples. Alternatively, the video encoding device may generate a prediction block and motion information of the current block based on inter prediction using the reconstructed pictures, the reconstructed motion vector field, and the neighboring motion information.

The video encoding device stores the motion information corresponding to a position of the current block in the motion vector field of the current block (S1606). In order to store the motion information at the position of the current block, the video encoding device may use a prediction mode based on intra prediction or motion information based on inter prediction: position information of the current block; and size information of the current block.

The video encoding device may generate the motion information of the current block using the neighboring motion information when the prediction block is generated based on the intra prediction. As an example, the video encoding device may generate a merge candidate list of the current block using the neighboring motion information and then set the motion information of the current block as motion information of a first candidate in the merge candidate list.

As another example, the video encoding device may set the motion information of the current block as top motion information or left motion information based on the shape of the current block. Here, the positions of the top motion information and the left motion information may be the closest top and closest left based on the top left of the current block.

The video encoding device compresses the motion vector field of the current block (S1608).

First, the video encoding device samples the motion vector field in motion vector sampling units. Thereafter, the video encoding device quantizes the sampled motion vector field to generate a compressed motion vector field.

In addition, the video encoding device may pad the motion information of the intra prediction region using the motion information included in the neighboring motion information regions for the intra prediction region on which intra prediction is performed in the sampled motion vector field.

As an example, the video encoding device first normalizes the size of the motion vectors included in the neighboring motion information region based on a difference between the POC of the current picture and the POC of the reference picture. Thereafter, the video encoding device may perform a weighted sum of the normalized motion vectors based on the distance between the intra prediction region and the neighboring motion information regions to generate the motion information of the intra prediction region. In addition, the video encoding device may determine the availability of neighboring motion information in a preset order, may select first available motion information, and then may set a reference list index of the intra prediction region to a reference list index of the selected motion information.

As another example, the video encoding device may set the motion information of the intra prediction region to motion information of the closest region among the neighboring motion information regions.

The video encoding device stores the compressed motion vector field in the decoded picture buffer (S1610).

The video encoding device subtracts the prediction block from the current block to generate a residual block (S1612).

The video encoding device encodes the residual block (S1614).

In addition, the video encoding device may generate a reconstructed residual block from the encoded residual block, and then may add the reconstructed residual block and the prediction block to generate a reconstructed block of the current block. The video encoding device may apply loop filters to a frame composed of reconstructed blocks to reconstruct the current picture, and then may store the reconstructed current picture in a decoded picture buffer.

FIG. 17 is a flowchart illustrating a method of decoding a current block by a video decoding device according to an embodiment of the present disclosure.

The video decoding device decodes the residual block of the current block from a bitstream (S1700).

The video decoding device obtains a compressed motion vector field and reconstructed pictures from the decoded picture buffer (S1702).

The video decoding device dequantizes the compressed motion vector field to generate a reconstructed motion vector field (S1704).

The video decoding device generates a prediction block of the current block based on intra prediction or generates a prediction block and motion information based on inter prediction (S1706). Here, the motion information includes a prediction mode, a motion vector, and a reference list index.

The video decoding device may generate a prediction block of the current block based on intra prediction using reconstructed neighboring samples. Alternatively, the video decoding device may generate a prediction block and motion information of the current block based on inter prediction using reconstructed pictures, a reconstructed motion vector field, and neighboring motion information.

The video decoding device stores motion information corresponding to the position of the current block in the motion vector field of the current block (S1708). In order to store motion information at the position of the current block, the video decoding device may use the prediction mode based on intra prediction or motion information based on inter prediction; position information of the current block; and size information of the current block.

The video decoding device compresses a motion vector field of the current block (S1710).

First, the video decoding device samples the motion vector field in motion vector sampling units. Thereafter, the video decoding device quantizes the sampled motion vector field to generate a compressed motion vector field.

The video decoding device stores the compressed motion vector field in a decoded picture buffer (S1712).

The video decoding device adds the residual block and the prediction block to generate a reconstructed block (S1714).

In addition, the video decoding device may reconstruct the current picture by applying loop filters to a frame including the reconstructed blocks and then may store the reconstructed current picture in the decoded picture buffer.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

120: predictor
155: entropy encoder
510: entropy decoder
540: predictor
610: motion vector field compressor
710: motion vector field compressor

1. A method of reconstructing a current block, performed by a video decoding device, the method comprising:
acquiring a compressed motion vector field and reconstructed pictures from a decoded picture buffer;
generating a reconstructed motion vector field by dequantizing the compressed motion vector field;
generating a prediction block of the current block based on intra prediction using reconstructed neighboring samples or generating the prediction block and motion information based on inter prediction using the reconstructed pictures, the reconstructed motion vector field, and neighboring motion information, wherein the motion information includes a prediction mode, a motion vector, and a reference list index; and
storing motion information corresponding to a position of the current block in the motion vector field of the current block based on a prediction mode according to the intra prediction or motion information according to the inter prediction, position information of the current block, and size information of the current block.

2. The method of claim 1, wherein storing in the motion vector field includes:
dividing a current coding block region corresponding to the current block into grids of the motion vector field; and
copying the motion information of the current block and storing the copied motion information in each grid.

3. The method of claim 1, wherein storing in the motion vector field includes:
when the prediction block is generated according to the intra prediction, generating a merge candidate list of the current block by using the neighboring motion information, and then setting the motion information of the current block to motion information of a first candidate in the list.

4. The method of claim 1, wherein storing in the motion vector field includes:
when the prediction block is generated based on the intra prediction, setting the motion information of the current block to top motion information or left motion information based on a shape of the current block,
wherein positions of the top motion information and the left motion information are a closest top and a closest left based on top left of the current block.

5. The method of claim 1, further comprising:
compressing the motion vector field of the current block; and
storing the compressed motion vector field in the decoded picture buffer.

6. The method of claim 5, wherein compressing the motion vector field includes:
sampling the motion vector field in motion vector sampling units; and
quantizing the sampled motion vector field to generate the compressed motion vector field.

7. The method of claim 6, wherein compressing the motion vector field further includes:
padding motion information of an intra prediction region in which the intra prediction is performed in the sampled motion vector field by using motion information included in neighboring motion information regions.

8. The method of claim 7, wherein padding the motion information includes:
normalizing sizes of motion vectors included in the neighboring motion information region based on a difference between a picture order count (POC) of a current picture and a POC of a reference picture, and then performing weighted sum of the normalized motion vectors based on a distance between the intra prediction region and the neighboring motion information regions to generate a motion vector of the intra prediction region.

9. The method of claim 8, wherein padding the motion information includes:
checking availability of neighboring motion information in a preset order to select first available motion information, and then setting a reference list index of the intra prediction region to a reference list index of the selected motion information.

10. The method of claim 7, wherein padding the motion information includes:
setting the motion information of the intra prediction region to motion information of a closest region among the neighboring motion information regions.

11. A method of encoding a current block, performed by a video encoding device, the method comprising:
acquiring a compressed motion vector field and reconstructed pictures from a decoded picture buffer;
generating a reconstructed motion vector field by dequantizing the compressed motion vector field;
generating a prediction block of the current block based on intra prediction using reconstructed neighboring samples or generating the prediction block and motion information based on inter prediction using the reconstructed pictures, the reconstructed motion vector field, and neighboring motion information, wherein the motion information includes a prediction mode, a motion vector, and a reference list index; and
storing motion information corresponding to a position of the current block in the motion vector field of the current block based on a prediction mode according to the intra prediction or motion information according to the inter prediction, position information of the current block, and size information of the current block.

12. The method of claim 11, wherein storing in the motion vector field includes:
when the prediction block is generated according to the intra prediction, generating a merge candidate list of the current block by using the neighboring motion information, and then setting the motion information of the current block to motion information of a first candidate in the list.

13. The method of claim 11, wherein storing in the motion vector field includes:
when the prediction block is generated according to the intra prediction, setting the motion information of the current block to top motion information or left motion information based on a shape of the current block,
wherein positions of the top motion information and the left motion information are a closest top and a closest left based on top left of the current block.

14. The method of claim 11, further comprising:
compressing the motion vector field of the current block; and
storing the compressed motion vector field in the decoded picture buffer.

15. The method of claim 14, wherein compressing the motion vector field includes:
sampling the motion vector field in motion vector sampling units; and
quantizing the sampled motion vector field to generate the compressed motion vector field.

16. The method of claim 15, wherein compressing the motion vector field further includes:
padding motion information of an intra prediction region in which the intra prediction is performed in the sampled motion vector field by using motion information included in neighboring motion information regions.

17. A computer-readable recording medium storing a bitstream generated by a video encoding method, the video encoding method comprising:
acquiring a compressed motion vector field and reconstructed pictures from a decoded picture buffer;
generating a reconstructed motion vector field by dequantizing the compressed motion vector field;
generating a prediction block of current block based on intra prediction using reconstructed neighboring samples or generating the prediction block and motion information based on inter prediction using the reconstructed pictures, the reconstructed motion vector field, and neighboring motion information, wherein the motion information includes a prediction mode, a motion vector, and a reference list index; and
storing motion information corresponding to a position of the current block in the motion vector field of the current block based on a prediction mode according to the intra prediction or motion information according to the inter prediction, position information of the current block, and size information of the current block.
